(19) United States
(12) Patent Application Publication
(10) Pub. No.: US 2008/0230015 A1
(43) Pub. Date: Sep. 25, 2008

(54) Braking Device for a Rope Pulley of a Leash that can be Mechanically Wound and Unwound for Leading Animals

(75) Inventor: Ernst-Peter Bleshoy, Hamburg (DE)

Correspondence Address: HOWSON AND HOWSON, SUITE 210, 501 OFFICE CENTER DRIVE, FT WASHINGTON, PA, 19034, US

(73) Assignee: FLEXI-BOGDAHN TECHNIK GMBH & CO. KG, Bargteheide (DE)

(21) Appl. No.: 12/049,553

(22) Filed: Mar. 17, 2008

(30) Foreign Application Priority Data
Mar. 20, 2007 (DE) 20 2007 004 273.6

(51) Int. Cl. A01K 27/00; B65H 75/30

(52) U.S. Cl. 119/796; 242/381.6

(57) ABSTRACT

A braking device for a rope pulley of a leash that can be wound and unwound mechanically for leading animals, in which the rope can be unwound against the force of a spring from the rope pulley and can be wound onto the rope pulley due to the force of the spring. The braking device includes a brake button, which can be brought from a rest position, in which the rope pulley can rotate freely, into an active position, in which the brake button blocks unwinding of the rope from the rope pulley. According to the invention, it is provided that the brake button has a top part, which projects from the leash housing and which allows actuation by the user, and a bottom part, which interacts with the rope pulley and which is connected so that it can pivot on the top part in such a way that the bottom part can pivot in the winding direction of the rope in such a way that, in the active position of the brake button, unwinding of the rope from the rope pulley is prevented and winding onto the rope pulley is possible, and that, in the active position, the free end of the bottom part contacts the rope pulley with friction, in order to pivot the bottom part through a rotational movement of the rope pulley in the winding direction.

### BACKGROUND OF THE INVENTION

The invention relates to a braking device for a rope pulley of a leash that can be mechanically wound and unwound for leading animals, in which the rope can be unwound from the rope pulley against the force of a spring and can be wound onto the rope pulley due to the force of the spring, wherein this braking device includes a brake button, which can be brought from a rest position, in which the rope pulley can rotate freely, into an active position, in which the brake button blocks the unwinding of the rope from the rope pulley. In particular, the invention relates to an automatic dog leash; such a dog leash is mainly discussed below, without being restricted thereby.

Such a braking device for dog leashes is known, for example, from DE 298 04 615 U1. Along its periphery, the rope pulley has a plurality of projections against which the brake button makes contact when it is in the pressed-down position. In this way, further unwinding of the rope from the rope pulley is prevented. The brake button can be locked in the pressed-down position by a locking lever. If the brake button is located in the rest position, the rope can be unrolled from the rope pulley against the force of a spring. If no tensile force acts on the rope, the rope is rewound onto the rope pulley due to the spring force.

One problem with such leashes arises when pulling a dog. Here, the dog leash must first be moved in the direction toward the dog with a released rope pulley. During this movement, the rope can be wound onto the rope pulley. Then the brake button is pressed, so that the rope pulley is locked during the pulling back movement of the hand and the rope is not unwound again. Consequently, a constant actuation of the brake button at the correct points in time is necessary, in order to shorten the leash despite the effect of a tensile force.

In principle, it is possible to construct the brake button in the form of a ratchet in such a way that, in the pressed down position, the brake button slides over the projection of the rope pulley during the winding movement. For the winding process, however, this causes unwanted noise, because the brake button has at least one spring element, which brings the brake button or its active part back into the engaged position when jumping over a projection. This produces rattling, which should be avoided.

### SUMMARY OF THE INVENTION

The invention is based on the problem of constructing a braking device of the type named above in such a way that it is also possible to wind the rope without generating noise when the brake button is pressed.

The problem is solved according to the invention in that the brake button has a top part, which projects from the leash housing and which allows actuation by the user, and a bottom part, which interacts with the rope pulley and is connected so that it can pivot on the top part in such a way that the bottom part can be pivoted in the winding direction of the rope in such a way that, in the active position of the brake button, unwinding of the rope from the rope pulley is prevented and winding onto the rope pulley is possible, and that, in the active position, the free end of the bottom part frictionally contacts the rope pulley, in order to pivot the bottom part through a rotational movement of the rope pulley in the winding direction. This arrangement allows winding of the rope also for a pressed-down brake button. Through the two-part construction of the brake button, it is achieved that the bottom part pivots in the winding movement of the rope pulley and thus no longer contacts the projections. By means of the friction, the bottom part is held in the pivoted position, in which it is out of engagement with the projections. Rattling is reliably avoided.

Due to the frictional connection between the bottom part and rope pulley, for a movement of the rope pulley in the other rotational direction, that is, in the unwinding direction, the bottom part is pivoted back into a position in which it is led into engagement with a projection of the rope pulley. The rope pulley is blocked. Therefore, it is possible to wind up the rope with the brake button pressed continuously.

The friction force is consequently used only for moving the bottom part of the rope pulley and can, accordingly, be small. Above all, a secure and easy winding of the rope can nevertheless be achieved, because the friction force is significantly smaller than the force of the spring acting on the rope pulley.

It is useful if the bottom part of the brake button is connected to the top part so that it can move in the press-in direction. This can be achieved, for example, in that the bottom part can pivot on a journal in or with an elongated hole and is connected to the top part so that it can move. Here it is especially useful if the bottom part is connected to the top part so that it can move against the force of a spring. In this way it is achieved that when the brake button is pressed down into its active position, the bottom part can move relative to the top part. The spring between the top part and the bottom part can be dimensioned in such a way that the same friction force is always generated independently of how firmly the brake button is pressed.

It is further useful if the brake button can be moved up to a stop in the direction toward the rope pulley. In this way, it is guaranteed that the bottom part is pressed onto the rope pulley only due to the spring force. Then the desired friction force can be set. In particular, it is achieved that the brake button can be pressed down only so far until the bottom part contacts the rope pulley with friction. A stronger pressure cannot be exerted without additional measures. It can be provided that the spring force is such that the rope pulley can rotate in the winding direction when the brake button is pressed up to the stop.

It is favorable when the bottom part has a concave construction relative to its rotational axis, such that it contacts the rope pulley with friction both in the non-pivoted position and also in the pivoted position. In this way, in the active position of the brake button, a constant contact of the bottom part with the rope pulley is realized, by which means a reliable back-and-forth pivoting of the bottom part is achieved for a change in the rotational direction.

The region where the bottom part contacts the rope pulley is basically arbitrary. It is useful, however, if the bottom part contacts the peripheral face of the rope pulley with friction. The rope pulley can have a flange, which extends past the projections laterally or ends flush with these projections. The peripheral surface of the flange is then easily accessible by the brake button.

Furthermore, the friction surface of the rope pulley can be provided with a friction element. The friction element can be constructed as an O-ring and be positioned around the periphery of the rope pulley. Such a friction element is easy to produce and assemble. It can also be partially sunk into a groove in the peripheral direction and can project only partially past the peripheral surface. This has the advantage that slippage of the friction element from the rope pulley is reliably prevented.

Furthermore, the friction surface of the bottom part can be made from wear-resistant material at least in the region that contacts the rope pulley with friction in the pivoted position, or can have a friction element made from wear-resistant material. During the winding, the bottom part always contacts the rope pulley. With such a wear-resistant material in the region of the friction surface, the wear can be reduced and a more reliable continuous operation can be guaranteed. The wear-resistant material can be made, for example, from a ceramic material and can be constructed as an insert for the friction surface.

According to a further embodiment of the invention, it is provided that the brake button can move outward past the stop in the direction toward the rope pulley after overcoming a lock. This has the advantage that the pressure on the brake button acts directly on the bottom part and thus the friction force can be increased, so that the rope pulley is also locked in the winding direction.

In detail, the arrangement can be realized in such a way that the elongated hole extends essentially parallel to the direction of movement of the brake button. When the brake button is pressed down and moves in the direction toward the rope pulley into the active position, the bottom part is pressed upward in the elongated hole relative to the top part and presses on the rope pulley in the stop position with only the spring force between the top part and the bottom part. If the stop is overpowered and the brake button is pressed in farther, the pivot pin is led to the end of the elongated hole. Then the pressure on the brake button can be transferred directly to the bottom part for generating a high friction force. The rope pulley is reliably stopped in both directions of rotation.

It can be provided that the lock can be overcome by applying a predetermined force on the top part. Then the friction force on the rope pulley can be increased through an instinctively stronger pressing of the brake button.

In principle, it is useful if the brake button can move against the force of a spring in the direction toward the rope pulley. Then the rope pulley is detached in the set rest position of the brake button and the dog can move freely according to the length of the leash.

It can be provided that the top part guides the bottom part along the displacement movement and that the top part forms a stop for the bottom part in the unwinding direction. In this way, it is guaranteed that in the pressed-down active position of the brake button, the bottom part is supported against the unwinding direction and can lock the rope pulley.

In addition, a locking lever can be provided that locks the brake button in the active position. It can be provided that the locking lever interacts with the top part of the brake button. Then the pulley is blocked, however, only in the unwinding direction, because the bottom part can still pivot.

Therefore, it is further useful if the locking lever in the locking position locks the rope pulley in the winding direction. This has the advantage that when the locking lever is activated, the rope pulley is locked in both rotational directions. The rope then has the selected length and neither winds nor unwinds.

Along its periphery, the rope pulley has a number of projections that interact with the bottom part in the unwinding direction when the brake button is pressed and that interact with the locking lever in the locking position of this locking lever, in order to lock the rope pulley in the winding direction. In detail, the arrangement can be realized in such a way that the projections have a saw tooth-shaped construction and have a radial edge, which forms the stop for the bottom part in the unwinding direction. In this way, a secure contact of the bottom part on the projection is realized. The edge inclined relative to the radial direction contacts the side of the projection in the winding direction and forms a stop for the locking lever in the winding direction.

The locking lever can be mounted in the leash housing so that it can pivot about a shaft between a detached position and the locked position and can have two projections, from which one interacts in the locked position with the top part of the brake button and the other interacts with the rope pulley. In this way, both the brake button can be held in its active position and the rope pulley can be held in the winding direction with the locking lever.

Furthermore, it is useful if the dimensions of the locking lever and the bottom part of the brake button are selected so that the rope pulley is held tightly or at least only with small play in the locked position. In this way, the rope is held tightly and the leash makes no noise in the locked and stopped state.

### BRIEF DESCRIPTION OF THE DRAWINGS

The invention will be explained in more detail below with reference to the schematic drawing. Shown are:

FIG. 1, a leash with a braking device according to the invention in longitudinal section,

FIGS. 2a-e, the leash according to FIG. 1 in different situations for a pressed brake button,

FIGS. 3a-c, the leash according to FIG. 1 in different situations for an activated locking lever,

FIG. 4, a cross section of the leash along line A-A in FIG. 1 in the rest position, and

FIG. 5, a cross section of the leash along line A-A in FIG. 1 for an actuated brake button.

### DETAILED DESCRIPTION OF THE PRESENT INVENTION

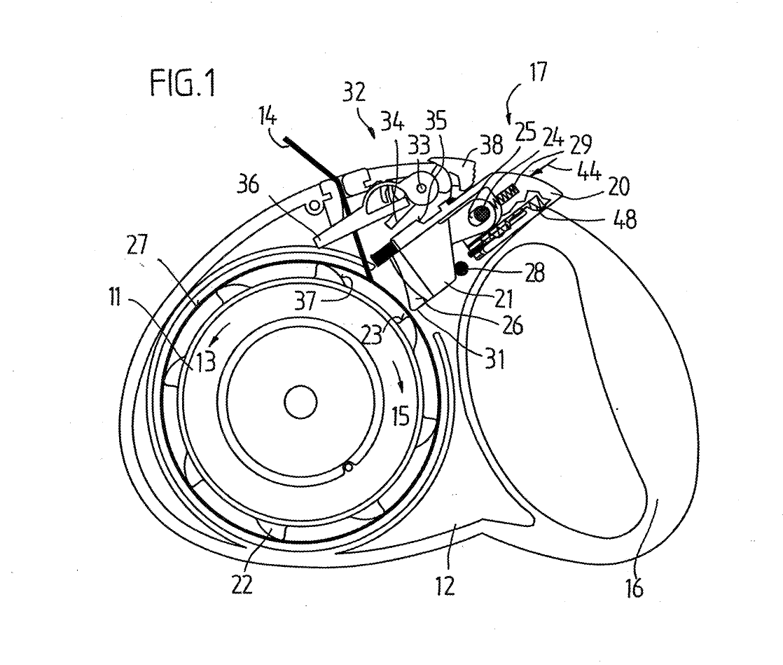

The leash shown in the drawing has a rope pulley 11, which is mounted so that it can rotate in a leash housing 12. A not-shown spring is provided, against whose force the rope pulley 11 can rotate in the unwinding direction 13 for unwinding the rope 14 and can rotate due to this spring force in the winding direction 15 for winding the rope. The housing 12 has a handle 16, with which the leash can be held. Furthermore, a braking device with a brake button 17 is provided, with which the rotation of the rope pulley can be blocked at least in the unwinding rotational direction 13. The leash housing has a two-shell construction, so that the separation plane lies in the plane of the drawing of FIG. 1 and includes an outlet opening 18 for the rope 14. The rope 14 can have a cord-like or belt-like construction. In this respect, the leash corresponds to a known leash with a rope that can be wound and therefore requires no additional explanation.

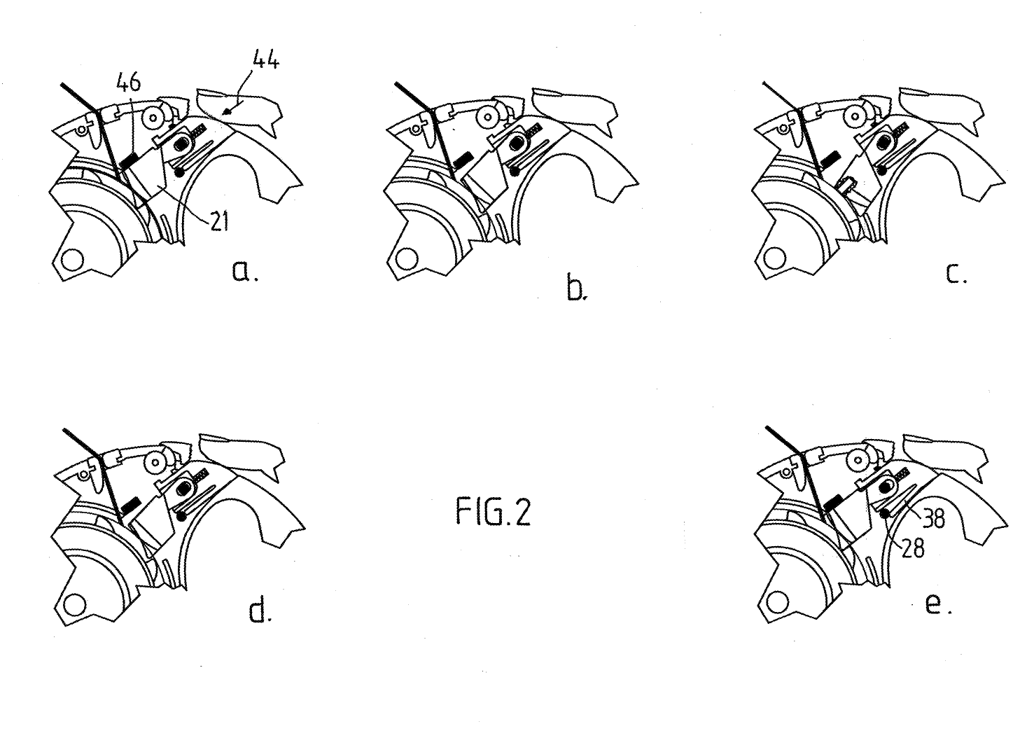

The brake button 17 is mounted in the leash housing so that it can move back and forth. Through pressure in the direction of the arrow 44 on the top part 20, the brake button is moved into the active position in the direction toward the rope pulley 11. The movement direction of the brake pulley runs approximately radially to the rope pulley. In the active position according to FIG. 2a, the bottom part 21 of the brake button interacts with projections 22, which are arranged on the rope pulley along the periphery. The saw tooth-shaped projections 22 have a front stop face 23, which runs radially to the rope pulley and which stops against the bottom part, so that the rotational movement of the rope pulley is blocked in the unwinding direction 13. The rope is prevented from being let out further.

The bottom part 21 is mounted so that it can rotate on the top part 20 of the brake button about a journal 24 in an elongated hole 25 and so that it can move in the direction of motion of the brake button. Furthermore, the bottom part 21 has a friction surface 26, which presses against the peripheral face 27 of the rope pulley 11 in the active position. The movement of the brake button 17 in the direction toward the rope pulley 11 is limited by a stop 28, which is mounted on the leash housing and against which the top part stops. In the stop position shown in FIG. 2a, the pivot pin 24 is located in the top region facing away from the rope pulley and preferably in approximately the center of the elongated hole 25. The dimensions, the position of the stop, and the length of the elongated hole are selected so that the pressure on the top part 20 of the brake button does not act directly on the bottom part in the active position. The pressure is instead received by the stop.

A spring 29, which presses the bottom part in the direction toward the rope pulley in the active position, is provided between the top part and the bottom part of the brake button. In this way and through the limiting of the path of the top part, it is achieved that the friction surface 26 of the bottom part presses on the rope pulley 11 with a defined force by the spring 29. The force of the spring is such that the friction force generated in this way is sufficient to pivot the bottom part about the pivot pin 24. Despite the contacting friction surface, the rope pulley can nevertheless rotate in the winding direction 15. The friction surface then slips past the periphery 27. An O-ring 30 can be provided which is arranged in a groove along the periphery of the rope pulley and which forms the friction surface of the rope pulley. Then an especially low-noise sliding of the bottom part on the rope pulley can be achieved.

Consequently, in the active position of the brake button, the rope pulley is prevented from rotating in the unwinding direction 13 by the projections 22 with a positive fit. In the winding direction 15, the bottom part 21 according to FIG. 2b is pivoted about the pivot pin 24 so that it is led out of engagement with the projections with its catch 31 facing the periphery of the rope pulley. Consequently, the rope pulley can rotate farther in the winding direction. As shown in FIG. 2c, the bottom part 21 is held by the constantly active friction force in the pivoted position past the projections 22 so that rattling noises are avoided.

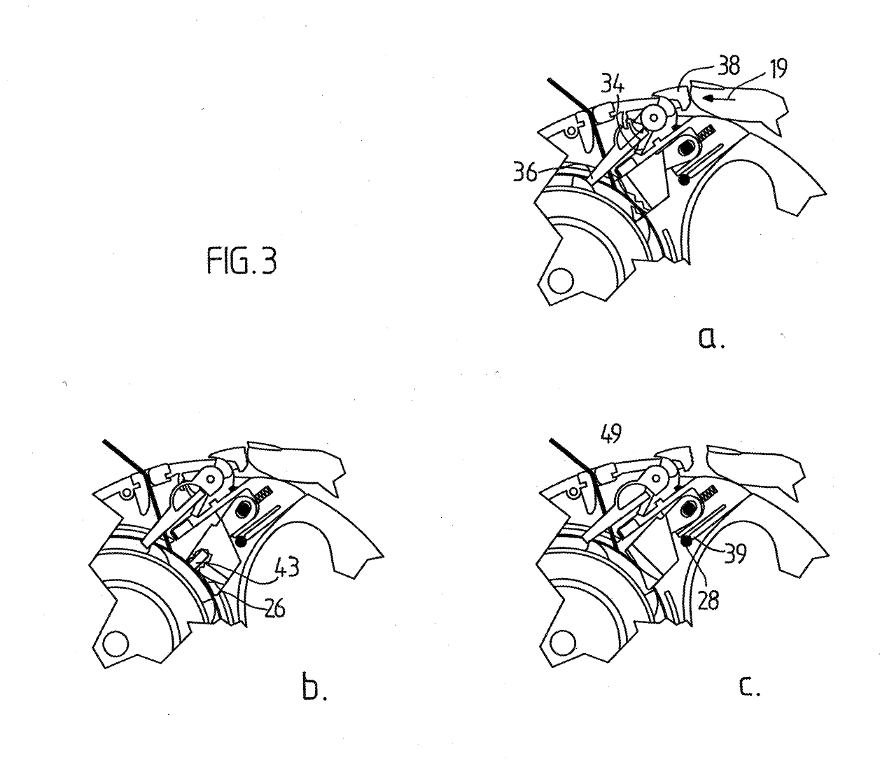

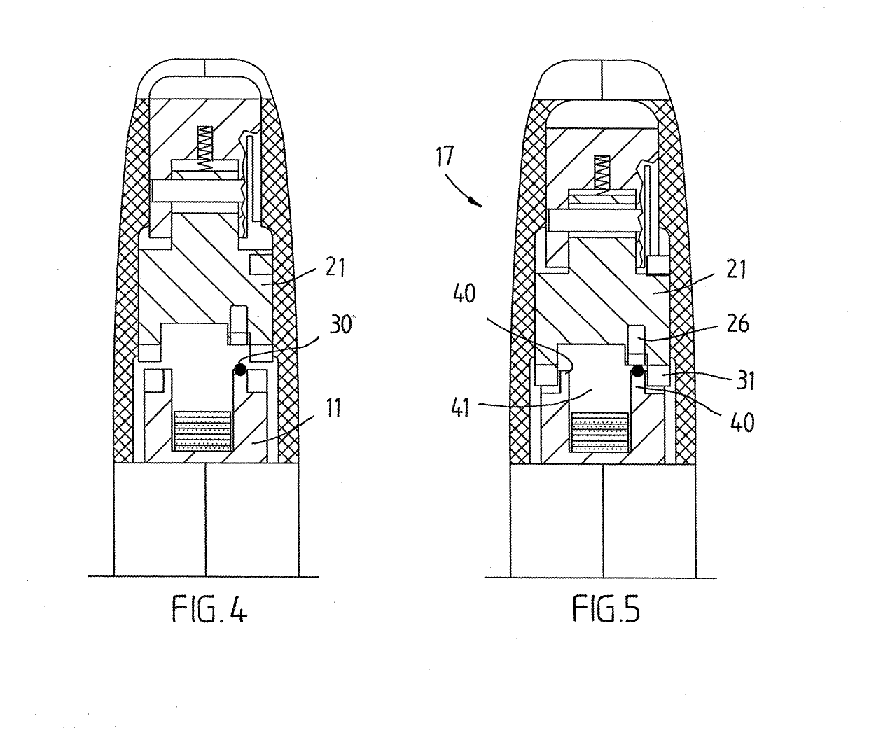

In the pivoted position, the bottom part is out of engagement with the projections of the rope pulley 11. Nevertheless, it contacts the peripheral surface 27 with friction when the brake button is pressed. It can be provided that the friction surface 26 of the bottom part 21 is made from a wear-resistant material or has a wear-resistant insert 43 in the region, which rubs on the peripheral surface or the O-ring in this pivoted position according to FIG. 2c. This insert is shown in FIG. 3b.

If the rope pulley 11 rotates back in the reverse rotational direction, that is, in the unwinding direction 13, through this friction, the bottom part 21 according to FIG. 2d is pivoted in the direction toward the rotary shaft of the rope pulley, wherein the catch 31 can be led back into engagement with the projections 22. Further rotation of the rope pulley in the unwinding direction 13 is prevented in the backward pivoted position of the bottom part according to FIG. 2e.

With such a construction it is possible to take in the rope when the brake button is pressed. The force of the spring 29 presses the bottom part only weakly on the periphery of the rope pulley, so that it can rotate farther in the winding direction due to the restoring force of the restoring spring of the rope pulley. The leash therefore must be moved in the direction toward the dog when the brake button is pressed, which decreases the tensile force and rotates the rope pulley in the winding direction. The bottom part 21 is pivoted and releases the rope pulley. The friction surface 26, however, remains in contact with the O-ring on the periphery of the rope pulley. The rope is wound. At the end of the movement in the direction toward the dog, the tension on the rope increases again, so that the rope pulley rotates again in the unwinding direction 13. By means of the friction, the bottom part is pivoted back so that the catch 31 can be led back into engagement with the projections 22. Further unwinding of the cable is prevented. The bottom part 21 is supported on a stop 46 of the top part or housing, wherein this stop limits the pivoting of the bottom part in the unwinding direction.

The leash further has a locking lever 32, with which the brake button can be locked in the pressed-down active position. The locking lever is mounted so that it can pivot in the housing about a rotary shaft 33 between a released position and a locked position. One end 38 is formed as an operating part and projects from the housing. It can be activated by a finger or the thumb of one hand. In the released position shown in FIG. 1, the operating part is located in the vicinity of the brake button. By shifting the operating part of the locking lever in the direction of the arrow 19 away from the brake button, the locking lever 32 is pivoted.

The locking lever 32 has a first projection 34, which is moved for the pivoting of the locking lever in the direction toward the brake button and can be led into engagement with a projection 35 of the top part 20 of the brake button when it is pressed down. Then the top part remains in the pressed-down position shown in FIG. 3a. If the locking lever is actuated when the brake button is not pressed, the projection 34 contacts the top part and prevents pivoting.

A second projection 36 is provided on the locking lever 32, which moves in the same direction as the first projection 34 and can also be led into engagement with the projections 22 of the deflection roll 11. If the locking lever is actuated for a pressed-down brake button when the bottom part 21 is in engagement with a projection, the second projection is led into engagement with the surface 37 of a projection of the rope pulley facing away from the stop surface 23. The surface 37 runs at an angle to the radial stop surface 23 in such a way that the free end of the projection 36 facing the rope pulley forms a good contact on the surface 37.

This completely blocked position is shown in FIG. 3a. Then the rope pulley can rotate neither in the unwinding direction nor in the winding direction, since the projection 36 blocks rotation in the winding direction. Through corresponding dimensions of the second projection 36 of the locking lever and the catch 31 of the bottom part 21, an essentially play-free blockage of the rope pulley can be realized.

FIG. 3b shows the situation when the locking lever 32 is pivoted into the locked position during the winding process and when the brake button is pressed. Then the rope pulley can rotate until the next projection is led into engagement with the second projection. In this position, the bottom part lies in its pivoted position and out of engagement with the projections. In this position, the rope pulley can rotate in the unwinding direction until the bottom part pivots back due to the rotational movement and the catch is led into engagement with a projection 22. The projection is hinged on the lever by means of a spring element 49, elastic in one direction so that the projection can move past a projection when it moves in the unwinding direction according to FIG. 3c. In the other direction, the projection is not flexible on the locking lever.

Then the catch of the bottom part 21 comes into engagement with a projection and the second projection 36 engages with the surface 37 of a projection, as shown in FIG. 3a. The rope pulley is located back in the completely blocked state.

The braking device allows secure holding of the animal through downward pressure without locking by the locking lever. If the leash is also to be braked during the winding process, the stop 28 can be passed over, so that the pressure on the brake button acts directly on the rope pulley. In detail, the arrangement is realized so that the stop 28 interacts with a moving plate 38 of the top part 20 of the brake button. For normal downward pressure of the brake button, the plate is in the rest position and the front edge 39 of the plate contacts against the stop 28. For an increased force in the direction toward the rope pulley, the plate is deflected and the top part can be pressed down farther. Then the pivot pin 24 comes onto the bottom end of the elongated hole 25 and the bottom part is pressed against the rope pulley with the pressure force exerted on the top part. A brake force, which is greater than the restoring force of the spring of the rope pulley, is generated through increased friction between the friction surface 26 and the O-ring 30 so that the winding movement is braked.

In a typical way, the rope pulley can have a middle winding space 41 for the rope. At the side, the winding space is limited by the flange 40. The projections 22 are arranged further outward. With the bottom part 21, the brake button surrounds the winding space 40 and is led into engagement with the catch. With their peripheral surface, one or two flanges form the friction surface for the bottom part. The O-ring can be sunk into a groove on one of the flanges on the outer peripheral surface. A compact construction is produced. The projections 22 and also the catches 31 can be provided on both sides of the rope pulley.

The operation of such a leash is simple. In the rest position, the dog can move freely according to the maximum rope length. When the brake button is pressed down, the rope length is limited and the rope is wound when the dog approaches the dog handler. In the locked position, the leash length is limited. All of the actuations can be performed with one hand. The brake button can be pressed into the line housing against the force of one spring 48 in the direction toward the rope pulley 11. If no force acts on the brake button and if the locking lever is in the released position, then the brake button always moves into its rest position.

1. A braking device for a rope pulley (11) of a leash that can be mechanically wound and unwound for leading animals, in which a belt or rope (14) can be unwound from the rope pulley against the force of a spring and can be wound onto the rope pulley due to the force of the spring, wherein this braking device includes a brake button (17), which can be brought from a rest position, in which the rope pulley can rotate freely, into an active position, in which the brake button blocks unwinding of the rope from the rope pulley, characterized in that the brake button has a top part (20), which projects from a leash housing (12) and which allows actuation by the user, and a bottom part (21), which interacts with the rope pulley and is connected so that it can pivot on the top part in such a way that the bottom part can pivot in a winding direction (15) of the rope in such a way that, in the active position of the brake button, an unwinding of the rope from the rope pulley is prevented and winding onto the rope pulley is possible, and that, in the active position, a free end (26) of the bottom part contacts the rope pulley (11) with friction, in order to pivot the bottom part through a rotational movement of the rope pulley in the winding direction.

2. A braking device according to claim 1, wherein the bottom part (21) of the brake button is connected to the top part (20) so that it can move in a press-in direction.

3. A braking device according to claim 2, wherein the bottom part (21) is connected to the top part (20) so that it can pivot and move on a journal (24) in or with an elongated hole (25).

4. A braking device according to claim 2, wherein the bottom part (21) is connected to the top part so that it can move against the force of a spring (29).

5. A braking device according to claim 4, wherein the brake button can move in a direction toward the rope pulley (11) up to a stop (28).

6. A braking device according to claim 5, wherein the force of the spring (29) is such that the rope pulley can rotate in the winding direction when the brake button is pressed up to the stop.

7. A braking device according to claim 5, wherein the brake button is moveable outward past the stop (28) in the direction toward the rope pulley after overpowering a lock (38).

8. A braking device according to claim 7, wherein the lock can be overpowered by application of a predetermined force on the top part.

9. A braking device according to claim 4, wherein the free end (26) of the bottom part (21) has a concave construction with respect to its rotational axis in such a way that it contacts the rope pulley with friction both in unpivoted and pivoted positions.

10. A braking device according to claim 1, wherein the bottom part (21) contacts an outer peripheral surface (27) of the rope pulley with friction.

11. A braking device according to claim 10, wherein the outer peripheral surface (27) of the rope pulley has a friction element (30).

12. A braking device according to claim 11, wherein the friction element (30) is an O-ring and is positioned around the periphery of the rope pulley.

13. A braking device according to claim 1, wherein the free end (26) of the bottom part is made from a wear-resistant material or has a friction element (43) made from friction-resistant material in the region, which contacts with the rope pulley with friction in a pivoted position.

14. A braking device according to claims 1, wherein the brake button is moveable in a direction toward the rope pulley against the force of a spring (45).

15. A braking device according to claim 1, wherein the top part (20) guides the bottom part (21) along displacement movement and wherein the top part forms a stop (43) for the bottom part in an unwinding direction.

16. A braking device according to claim 1, further comprising a locking lever (32) for locking the brake button (17) in the active position.

17. A braking device according to claim 16, wherein the locking lever (32) is engageable with the top part (20) of the brake button.

18. A braking device according to claim 16, wherein, when the locking lever is in a locked position, the locking lever (32) blocks movement of the rope pulley in the winding direction (15).

19. A braking device according to one of claim 18, wherein the rope pulley has a number of projections (22) along its periphery that interact with the bottom part of the brake button in an unwinding direction (13) of the rope pulley when the brake button is pressed and that interact with the locking lever in the locked position of this locking lever (32) to block the rope pulley in the winding direction.

20. A braking device according to claim 19, wherein the locking lever (32) is mounted in the leash housing such that it can pivot between a released position and the locked position about a shaft (33) and has two projections (34, 36), one of which interacts with the top part (20) of the brake button in the locked position and the other interacts with the rope pulley (11).

21. A braking device according to one of claims 19, wherein the dimensions of the locking lever (32) and the bottom part (21) of the brake button are such that the rope pulley is held tightly or with at least only little play in the locked position.
